(19) United States
(12) Patent Application Publication
(10) Pub. No.: US 2026/0240117 A1
(43) Pub. Date: Aug. 20, 2026

(54) Dog poop collector

(71) Applicant: TAE KYOU Kim, Irvine, CA (US)

(72) Inventor: TAE KYOU Kim, Irvine, CA (US)

(21) Appl. No.: 19/056,604

(22) Filed: Feb. 18, 2025

(51) Int. Cl. A01K 23/00

(52) U.S. Cl. CPC A01K 23/005

(57) ABSTRACT

The present invention relates to a portable and hygienic dog poop collector that utilizes an air-powered inflation and deflation mechanism. The device comprises an air-inflatable polybag equipped with air tube components, which expand into a basket-like structure when air is supplied by a compact air pump. This allows for efficient and hands-free collection of dog waste. Once the waste is collected, the air pump deflates the structure, shrinking the polybag for easy disposal. The design offers a lightweight, portable, and convenient solution for pet owners, improving cleanliness and usability during dog walks.

### BACKGROUND OF THE INVENTION

Dealing with dog poop is one of the more cumbersome tasks of dog ownership. Over time, many inventions have been developed to assist with this issue, primarily focusing on grabbing or holding the waste. However, most existing solutions still lack portability and convenience.

Current designs often require long-handled tools or noose-style loops to spread a polybag for collecting waste, but these devices can be bulky and impractical for everyday walks. The purpose of this invention is to create a more compact and portable tool for picking up dog waste—one that does not interfere with walking the dog yet remains practical and efficient when needed.

Patent U.S. Pat. No. 7,631,910B2 describes a dog poop collector that features a dustpan with an adjustable handle.

Patent U.S. Pat. No. 7,854,455B2 discloses a dog poop collector equipped with two elastic arms designed to hold a polybag attached to a long stick. When collecting poop, the polybag can be easily detached and disposed of in a trash bin.

Patent U.S. Pat. No. 8,177,270B2 presents an adjustable stick with two ring-shaped loops that create a gap for securing a polybag. Once the dog poop is collected in the bag, it can be released from the loops and discarded in a trash bin.

Patent U.S. Pat. No. 9,095,127B2 introduces a dog poop grabber with two separate gripping clamp parts. These clamps can open and close through a string mechanism controlled by a handle, which transmits movement to the clamping parts via a wire.

Patent U.S. Pat. No. 9,832,980B2 describes a dog poop clamping tool with two clamping fingers operated by a handle. The handle's action controls the opening and closing of the fingers through a wire mechanism that transmits movement from the handle to the clamps.

The aforementioned inventions primarily focus on utilizing gripping mechanisms and long handles for poop collection. In contrast, this invention aims to provide a compact, portable, and hygienic solution for handling dog waste more conveniently by introducing a pop-up poop collecting basket. This basket remains in a small, compact size when not in use, making it easy to carry, and expands when needed for waste collection

### BRIEF SUMMARY OF THE INVENTION

To create a highly portable and hygienic tool for handling dog waste, this invention utilizes air-powered functionality.

Air is supplied to a polybag equipped with air tubes, inflating it into a basket-like shape to securely hold dog waste. The air is provided by a compact, portable air pump.

Once the waste is collected, the air pump's deflation function collapses the inflated basket, allowing the polybag to shrink. The deflated polybag can then be easily detached from the air pump and disposed of conveniently in a garbage bin.

### BRIEF DESCRIPTION OF THE SEVERAL VIEWS OF THE DRAWINGS

FIG. 1 illustrates the overall functionality of the invention. The poop collector (1) is inflated by air supplied from the air pump (2), allowing it to collect dog waste.

FIG. 2 shows the fully inflated poop collector (1) along with the air pump (2).

FIG. 3 presents the air tube component of the poop collector (1).

FIG. 4 displays the non-inflated part of the poop collector (1).

FIG. 5 illustrates the poop collector (1) in its shrunken state before inflation.

FIG. 6 demonstrates the initial stage of air being supplied to the air tube section of the poop collector (1).

FIG. 7 depicts an increased air supply inflating the air tube section further.

FIG. 8 shows the air fully distributed throughout the air tube section, achieving full inflation of the poop collector (1).

FIG. 9 illustrates the air deflation process, where air exits from the air tube section through the outlet of the air pump (2).

### DETAILED DESCRIPTION OF THE INVENTION

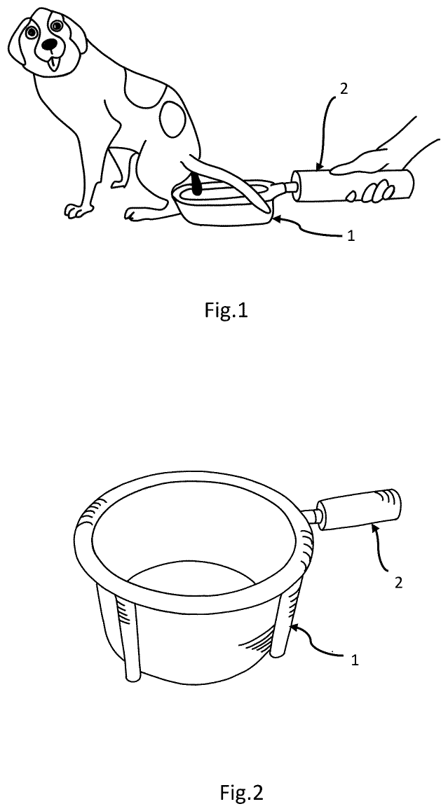

With FIG. 1, when the dog assumes a half-squatting position to defecate, the owner attaches the poop collector (1) to the air pump (2) and presses the start button on the air pump to inflate the poop collector (1).

Once the dog has finished defecating, the owner presses the deflation switch on the air pump (2), allowing air to be released from the poop collector (1), causing it to shrink and become compact.

Finally, the owner disconnects the poop collector (1) from the air pump (2) and disposes of it in a garbage can.

FIG. 2 shows the complete view of the invention. The poop collector (1), connected to the air pump (2), is fully inflated and ready to collect waste. The height and diameter of the poop collector (1) can be adjusted to accommodate dogs of different sizes.

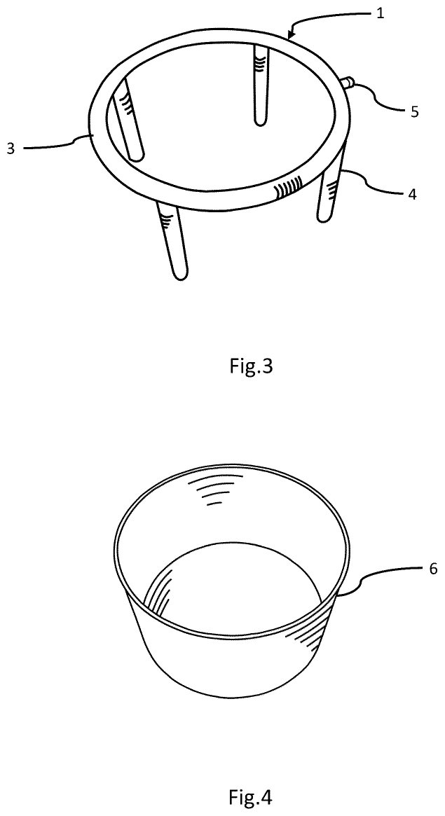

FIG. 3 shows the air tube components of the poop collector (1). It consists of the main tube (3), leg tubes (4), and the connector (5), which attaches to the air pump (2). Air from the air pump (2) is first supplied to the main tube (3), and almost simultaneously, it flows into the leg tubes (4) due to their direct connection

Through the connector (5), air is supplied to main tube (3) and leg tubes (4). The number of leg tubes (4) can be adjusted to suit the shape and efficiency of the collector.

The non-air tube section (6), shown in FIG. 4, is made of polyvinyl material, designed to collect waste, and is integrated with the air tube sections (3) and (4).

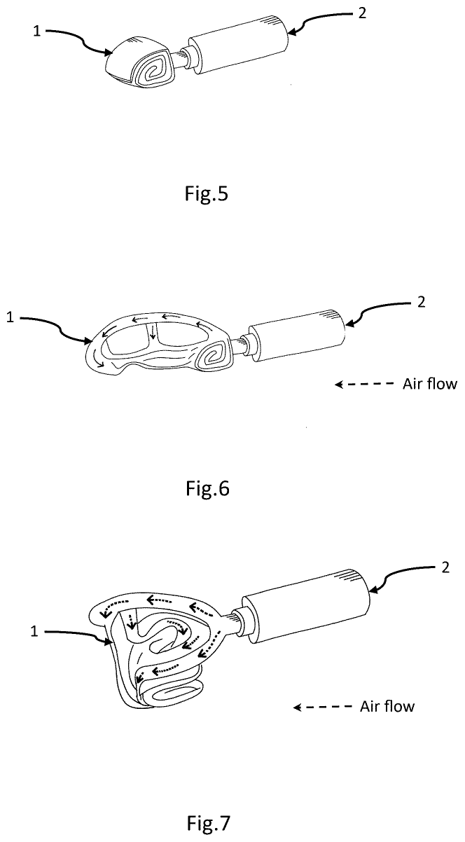

FIG. 5 shows the state of the non-inflated poop collector (1) connected to the air pump (2). Before air is supplied to the poop collector (1), it remains compact and small, making it easy to carry during walks.

FIG. 6 illustrates the air pump (2) supplying air into the poop collector (1), causing air circulation inside the air tubes, leading to inflation.

FIG. 7 shows the continued air deployment inside the air tube section, with further inflation taking place.

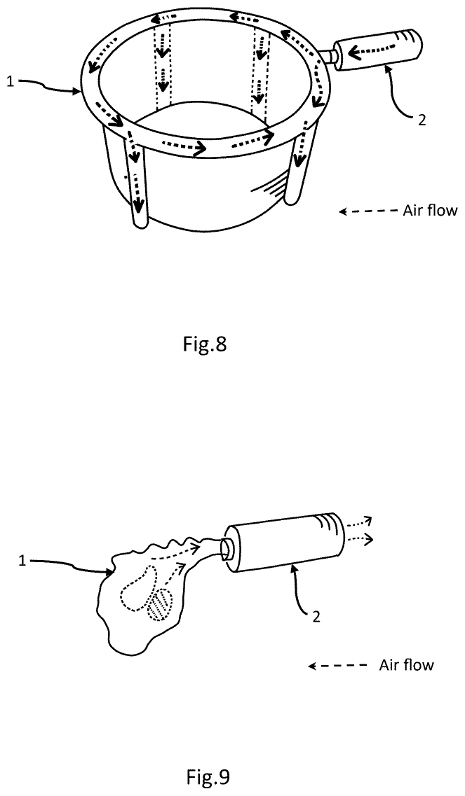

FIG. 8 depicts the poop collector (1) fully inflated and ready to collect waste. The arrows indicate the direction of air circulation, with air fully inflating the main tube (3) and leg tubes (4), allowing the poop collector (1) to stand upright and form a basket shape for waste collection.

FIG. 9 shows the poop collector (1) in its deflated state, with most of the air drained out.

Once the dog finishes defecating, the owner presses the deflation button on the air pump (2), which releases the air from the main tube (3) and leg tubes (4) of the poop collector (1).

The deflated poop collector (1) is then detached from the air pump (2) and can be disposed in a garbage can.

1. The dog poop collector (1) consists of air tube parts (3) and (4) and a non-air tube part (6). The poop collector (1) inflates to collect poop and deflates after collection.

2. The air pump (2) supplies and removes air from the air tube parts (3) and (4) of the poop collector (1), enabling inflation and deflation.
